(19) United States
(12) Patent Application Publication
(10) Pub. No.: US 2018/0247199 A1
(43) Pub. Date: Aug. 30, 2018

(54) METHOD AND APPARATUS FOR MULTI-DIMENSIONAL SEQUENCE PREDICTION

(71) Applicant: QUALCOMM Incorporated, San Diego, CA (US)

(72) Inventor: Jonathan Albert COX, San Diego, CA (US)

(21) Appl. No.: 15/881,287

(22) Filed: Jan. 26, 2018

Related U.S. Application Data
(60) Provisional application No. 62/463,484, filed on Feb. 24, 2017.

(51) Int. Cl. G06N 3/08; G06N 3/04

(52) U.S. Cl. CPC G06N 3/084; G06N 3/0445

(57) ABSTRACT

In an aspect of the disclosure, a method, a computer-readable medium, and an apparatus for a neural network are provided. The neural network may be a multi-dimensional recurrent neural network. The multi-dimensional recurrent neural network may be trained via multi-dimensional backpropagation through time. The apparatus may receive a multi-dimensional input for the neural network. The apparatus may generate a multi-dimensional output for the neural network. At least one dimension of the multi-dimensional output may have variable length that is unrelated to dimensional lengths of the multi-dimensional input.

### CROSS-REFERENCE TO RELATED APPLICATION(S)

The claims the benefit of U.S. Provisional Application 62/463,484, filed on Feb. 24, 2017 and entitled “METHOD AND APPARATUS FOR MULTI-DIMENSIONAL SEQUENCE PREDICTION,” the disclosure of which is incorporated herein by reference in its entirety.

### BACKGROUND

### Field

The present disclosure relates generally to machine learning, and more particularly, to neural networks for multi-dimensional sequence prediction.

### Background

An artificial neural network, which may include an interconnected group of artificial neurons, may be a computational device or may represent a method to be performed by a computational device. Artificial neural networks may have corresponding structure and/or function in biological neural networks. However, artificial neural networks may provide useful computational techniques for certain applications in which conventional computational techniques may be cumbersome, impractical, or inadequate. Because artificial neural networks may infer a function from observations, such networks may be useful in applications where the complexity of the task or data makes the design of the function by conventional techniques burdensome.

Convolutional neural networks are a type of feed-forward artificial neural network. Convolutional neural networks may include collections of neurons that each has a receptive field and that collectively tile an input space. Convolutional neural networks (CNNs) have numerous applications. In particular, CNNs have broadly been used in the area of pattern recognition and classification.

Recurrent neural networks (RNNs) are a class of neural network that includes a cyclical connection between nodes or units of the network. The cyclical connection creates an internal state that may serve as a memory that enables recurrent neural networks to model dynamical systems. That is, the cyclical connections offer recurrent neural networks the ability to encode memory and as such, these networks, if successfully trained, are suitable for sequence learning applications.

A recurrent neural network may be used to implement a long short-term memory (LSTM) in a microcircuit composed of multiple units to store values in memory using gating functions and multipliers. LSTMs are able to hold a value in memory for an arbitrary length of time. As such, LSTMs may be useful in learning, classification systems (e.g., handwriting and speech recognition systems), and other applications.

In conventional systems, a recurrent network, such as a recurrent neural network, is used to model sequential data. Recurrent neural networks may handle vanishing gradients. Thus, recurrent neural networks may improve the modeling of data sequences. Consequently, recurrent neural networks may increase the modelling accuracy of the temporal structure of sequential data, such as videos.

Traditionally, neural network (deep learning) architectures have been used to map fixed length inputs to fixed length outputs. For example, mapping static images to a fixed set of categories, such as dog, cat, bird, etc. It is also possible to use such a network to map sequences, but such use requires a sliding window approach that often suffers from reduced performance.

For a certain class of problems, at every time step, a fixed length input may need to be mapped to a variable length output sequence. In this way, the output sequences become a multi-dimensional sequence with two or more dimensions (e.g., one dimension is time and another dimension is the sequence). Moreover, the mapping of a fixed length input to a variable length sequence should be performed in a way that the predicted sequence at time t receives information from the surrounding sequences at earlier and later times, such as t−1 or t+1. This class of problems may be referred to as multi-dimensional sequence prediction (MDSP) problems. Traditional neural networks, including traditional RNNs, may not be able to handle MD SP problems.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Traditional neural networks, including traditional RNNs, may not be able to handle MDSP problems. In an aspect of the disclosure, a method, a computer-readable medium, and an apparatus for a neural network are provided. The neural network may be a multi-dimensional recurrent neural network (MD-RNN). The MD-RNN may be trained via multi-dimensional backpropagation through time (MD-BPTT). The apparatus may receive a multi-dimensional input for the neural network. The apparatus may generate a multi-dimensional output for the neural network. At least one dimension of the multi-dimensional output may have variable length that is unrelated to dimensional lengths of the multi-dimensional input.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a neural network in accordance with aspects of the present disclosure.

FIG. 2 is a block diagram illustrating an exemplary deep convolutional network (DCN) in accordance with aspects of the present disclosure.

FIG. 3 is a schematic diagram illustrating a recurrent neural network.

FIG. 4 is a diagram illustrating an example of applying MDSP to blind source separation.

FIG. 5 is a diagram illustrating an example of detecting objects in a single image.

FIG. 6 is a diagram illustrating an example of a multi-dimensional sequence prediction network.

FIG. 7 is a diagram illustrating an example of a fully connected multi-dimensional sequence prediction network.

FIG. 8 is a flowchart of a method of a neural network.

FIG. 9 is a conceptual data flow diagram illustrating the data flow between different means/components in an exemplary apparatus.

FIG. 10 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computing systems for artificial neural networks will now be presented with reference to various apparatus and methods. The apparatus and methods will be described in the following detailed description and illustrated in the accompanying drawings by various blocks, components, circuits, processes, algorithms, etc. (collectively referred to as “elements”). The elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

An artificial neural network may be defined by three types of parameters: 1) the interconnection pattern between the different layers of neurons; 2) the learning process for updating the weights of the interconnections; and 3) the activation function that converts a neuron's weighted input to the neuron's output activation. Neural networks may be designed with a variety of connectivity patterns. In feed-forward networks, information is passed from lower layers to higher layers, with each neuron in a given layer communicating with neurons in higher layers. A hierarchical representation may be built up in successive layers of a feed-forward network. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

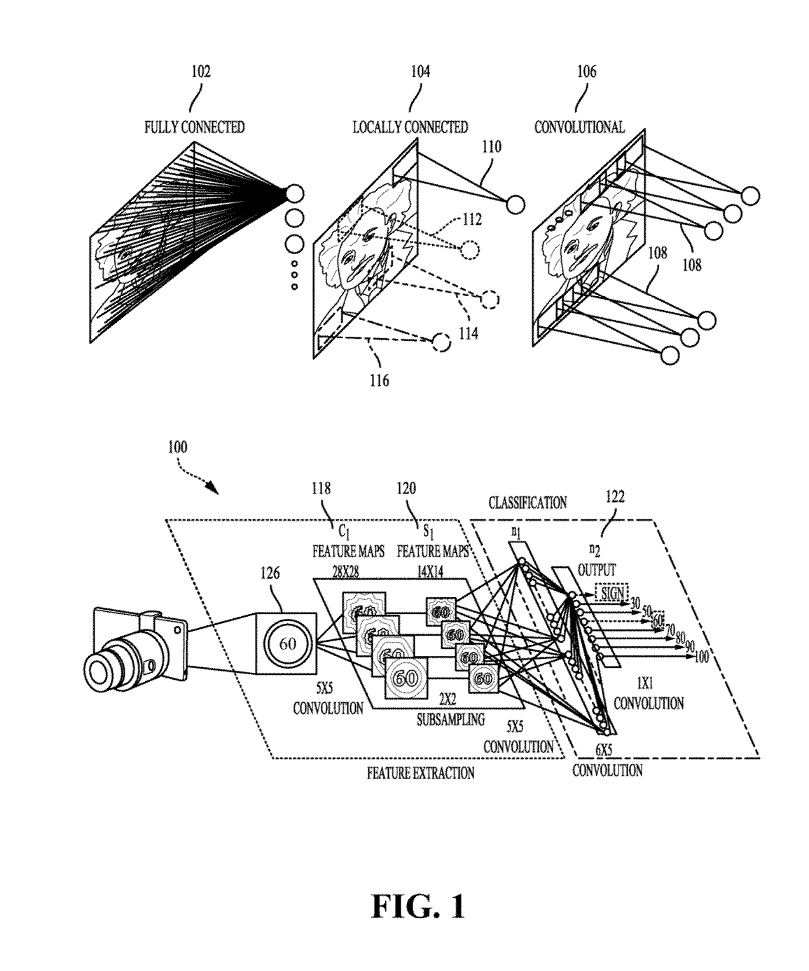

FIG. 1 is a diagram illustrating a neural network in accordance with aspects of the present disclosure. As shown in FIG. 1, the connections between layers of a neural network may be fully connected 102 or locally connected 104. In a fully connected network 102, a neuron in a first layer may communicate the neuron's output to every neuron in a second layer, so that each neuron in the second layer receives an input from every neuron in the first layer. Alternatively, in a locally connected network 104, a neuron in a first layer may be connected to a limited number of neurons in the second layer. A convolutional network 106 may be locally connected, and may be further configured such that the connection strengths associated with the inputs for each neuron in the second layer are shared (e.g., connection strength 108). For example, a locally connected layer of a network may be configured so that each neuron in the locally connected layer will have the same or a similar connectivity pattern, but with connections strengths that may have different values (e.g., 110, 112, 114, and 116). The locally connected connectivity pattern may give rise to spatially distinct receptive fields in a higher layer, because the higher layer neurons in a given region may receive inputs that are tuned through training to the properties of a restricted portion of the total input to the network.

Locally connected neural networks may be well suited to solving problems in which the spatial location of inputs is meaningful. For instance, a neural network 100 designed to recognize visual features from a car-mounted camera may develop high layer neurons with different properties depending on their association with the lower portion of the image versus the upper portion of the image. Neurons associated with the lower portion of the image may learn to recognize lane markings, for example, while neurons associated with the upper portion of the image may learn to recognize traffic lights, traffic signs, and the like.

A deep convolutional network (DCN) may be trained with supervised learning. During training, a DCN may be presented with an image, such as a cropped image of a new image 126 (e.g., speed limit sign), and a “forward pass” may then be computed to produce an output 122. The output 122 may be a vector of values corresponding to features such as “sign,” “60,” and “100.” The network designer may want the DCN to output a high score for some of the neurons in the output feature vector, for example the ones corresponding to “sign” and “60” as shown in the output 122 for a neural network 100 that has been trained. Before training, the output produced by the DCN is likely to be incorrect. During training, an error may be calculated between the actual output of the DCN and the target output desired from the DCN. The weights of the DCN may then be adjusted so that the output scores of the DCN are more closely aligned with the target output.

To adjust the weights, a learning algorithm may compute a gradient vector for the weights. The gradient may indicate an amount that an error would increase or decrease if the weights were slightly adjusted. At the top layer, the gradient may correspond directly to the value of a weight associated with an interconnection connecting an activated neuron in the penultimate layer and a neuron in the output layer. In lower layers, the gradient may depend on the value of the weights and on the computed error gradients of the higher layers. The weights may then be adjusted so as to reduce the error. Such a manner of adjusting the weights may be referred to as “back propagation” as the manner of adjusting weights involves a “backward pass” through the neural network.

In practice, the error gradient for the weights may be calculated over a small number of examples, so that the calculated gradient approximates the true error gradient. Such an approximation method may be referred to as a stochastic gradient descent. The stochastic gradient descent may be repeated until the achievable error rate of the entire system has stopped decreasing or until the error rate has reached a target level.

After learning, the DCN may be presented with new images 126 and a forward pass through the network may yield an output 122 that may be considered an inference or a prediction of the DCN.

Deep convolutional networks (DCNs) are networks of convolutional networks, configured with additional pooling layers and normalization layers. DCNs may achieve state-of-the-art performance on many tasks. DCNs may be trained using supervised learning in which both the input and output targets are known for many exemplars The known input targets and output targets may be used to modify the weights of the network by use of gradient descent methods.

DCNs may be feed-forward networks. In addition, as described above, the connections from a neuron in a first layer of a DCN to a group of neurons in the next higher layer of the DCN may be shared across the neurons in the first layer. The feed-forward and shared connections of DCNs may be exploited for fast processing. The computational burden of a DCN may be much less, for example, than the computational burden of a similarly sized neural network that includes recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered a three-dimensional network, with two spatial dimensions along the axes of the image and a third dimension capturing color information. The outputs of the convolutional connections may be considered to form a feature map in the subsequent layer 118 and 120, with each element of the feature map (e.g., in layer 120) receiving input from a range of neurons in the previous layer (e.g., 118) and from each of the multiple channels. The values in the feature map may be further processed with a non-linearity, such as a rectification function, max(0,x). Values from adjacent neurons may be further pooled, which corresponds to down sampling, and may provide additional local invariance and dimensionality reduction. Normalization, which corresponds to whitening, may also be applied through lateral inhibition between neurons in the feature map.

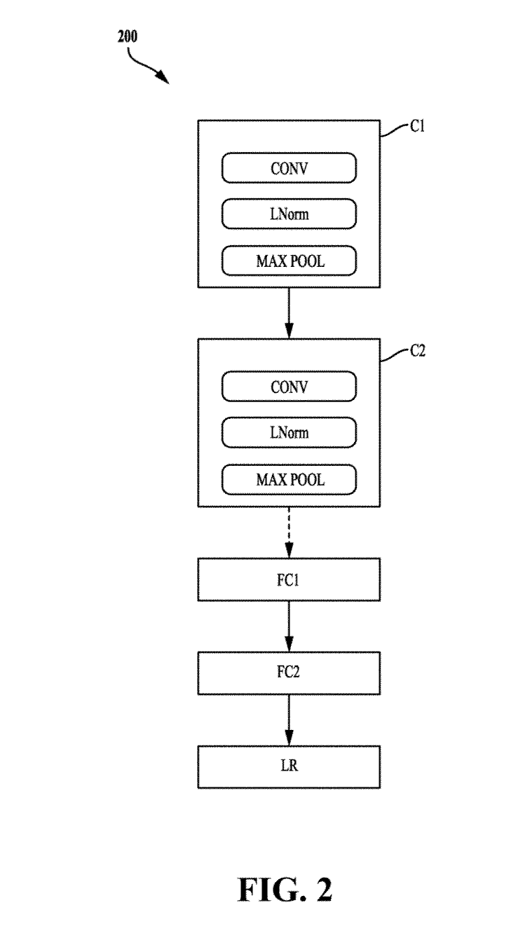

FIG. 2 is a block diagram illustrating an exemplary deep convolutional network 200. The deep convolutional network 200 may include multiple different types of layers based on connectivity and weight sharing. As shown in FIG. 2, the exemplary deep convolutional network 200 includes multiple convolution blocks (e.g., C1 and C2). Each of the convolution blocks may be configured with a convolution layer (CONV), a normalization layer (LNorm), and a pooling layer (MAX POOL). The convolution layers may include one or more convolutional filters, which may be applied to the input data to generate a feature map. Although two convolution blocks are shown, the present disclosure is not so limited, and instead, any number of convolutional blocks may be included in the deep convolutional network 200 according to design preference. The normalization layer may be used to normalize the output of the convolution filters. For example, the normalization layer may provide whitening or lateral inhibition. The pooling layer may provide down sampling aggregation over space for local invariance and dimensionality reduction.

The parallel filter banks, for example, of a deep convolutional network may be loaded on a CPU or GPU of a system on a chip (SOC), optionally based on an Advanced RISC Machine (ARM) instruction set, to achieve increased performance and reduced power consumption. In alternative embodiments, the parallel filter banks may be loaded on the DSP or an image signal processor (ISP) of an SOC. In addition, the DCN may access other processing blocks that may be present on the SOC, such as processing blocks dedicated to sensors and navigation.

The deep convolutional network 200 may also include one or more fully connected layers (e.g., FC1 and FC2). The deep convolutional network 200 may further include a logistic regression (LR) layer. Between each layer of the deep convolutional network 200 are weights (not shown) that may be updated. The output of each layer may serve as an input of a succeeding layer in the deep convolutional network 200 to enable the network to learn hierarchical feature representations from the input data (e.g., images, audio, video, sensor data and/or other input data) supplied at the first convolution block C1.

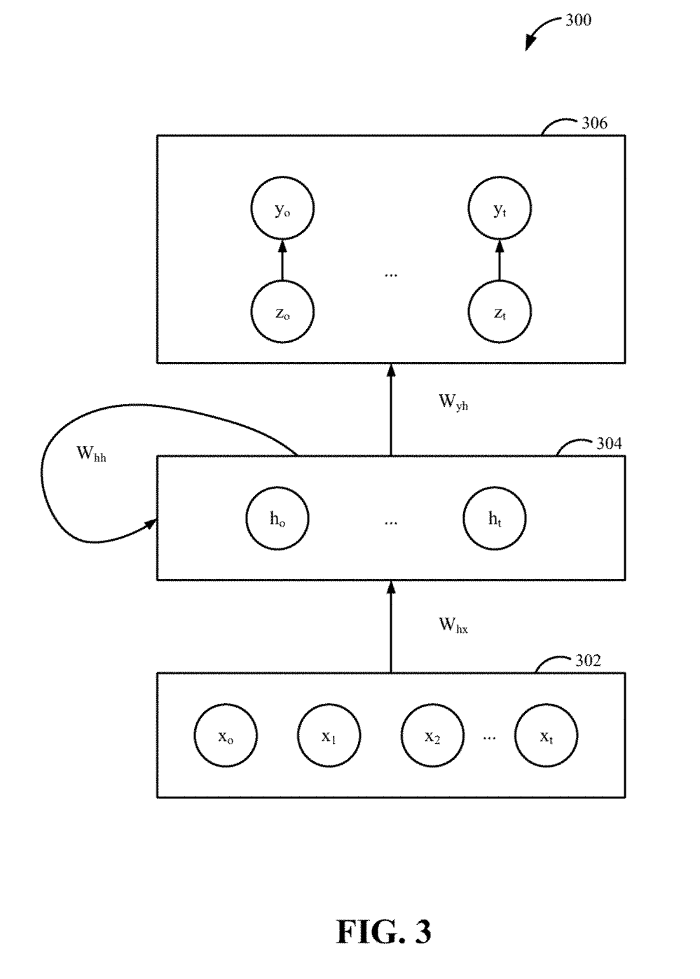

FIG. 3 is a schematic diagram illustrating a recurrent neural network (RNN) 300. The recurrent neural network 300 may include an input layer 302, a hidden layer 304 with recurrent connections, and an output layer 306. Given an input sequence X with multiple input vectors x_{T} (e.g., X={x₀, x₁, x₂ . . . x_{T}}), the recurrent neural network 300 predicts a classification label yₜ for each output vector z_{T} of an output sequence Z (e.g., Z={z₀ . . . z_{T}}). For FIG. 3, xₜ∈ [symbol] ^{N}, yₜ∈ [symbol] ^{C}, and zₜ∈ [symbol] ^{C}. As shown in FIG. 3, a hidden layer 304 with M units (e.g., hₒ . . . hₜ) is specified between the input layer 302 and the output layer 306. The M units of the hidden layer 304 store information about the previous values (\acute{t}<t) of the input sequence X. The M units may be computational nodes (e.g., neurons). In one configuration, the recurrent neural network 300 receives an input x_{T} and generates a classification label yₜ of the output z_{T} by iterating the equations:

sₜ=Wₕₓ_{^{x}}ₜ+Wₕₕhₜ₋₁+bₕ (1)

hₜ=ƒ(sₜ) (2)

oₜ=W_{yh}hₜ+b_{y} (3)

yₜ=g(oₜ) (4)

where Wₕₓ, Wₕₕ, and W_{yh} are the weight matrices, bₕ and b_{y} are the biases, sₜ∈ [symbol] ^{M} and oₜ∈ [symbol] ^{C} are inputs to the hidden layer 304 and the output layer 306, respectively, and ƒ and g are nonlinear functions. The function ƒ may comprise a rectifier linear unit (RELU) and, in some aspects, the function g may comprise a linear function or a softmax function. In addition, the hidden layer nodes may be initialized to a fixed bias bi such that at t=0 hₒ=bi. In some aspects, bi may be set to zero (e.g., bi=0). The objective function, C(θ), for a recurrent neural network with a single training pair (x,y) is defined as C(θ)=ΣₜLₜ(z, y(θ)), where θ represents the set of parameters (weights and biases) in the recurrent neural network. For regression problems, Lₜ=∥(zₜ−yₜ)²∥ and for multi-class classification problems, Lₜ=−Σⱼzₜⱼ log(yₜⱼ).

The neural network 100, the deep convolutional network 200, or the recurrent neural network 300 may be emulated by a general purpose processor, a digital signal processor (DSP), an application specific integrated circuit (ASIC), a field programmable gate array (FPGA) or other programmable logic device (PLD), discrete gate or transistor logic, discrete hardware components, a software component executed by a processor, or any combination thereof. The neural network 100, the deep convolutional network 200, or the recurrent neural network 300 may be utilized in a large range of applications, such as image recognition, pattern recognition, machine learning, motor control, and the like. Each neuron in the neural network 100, the deep convolutional network 200, or the recurrent neural network 300 may be implemented as a neuron circuit.

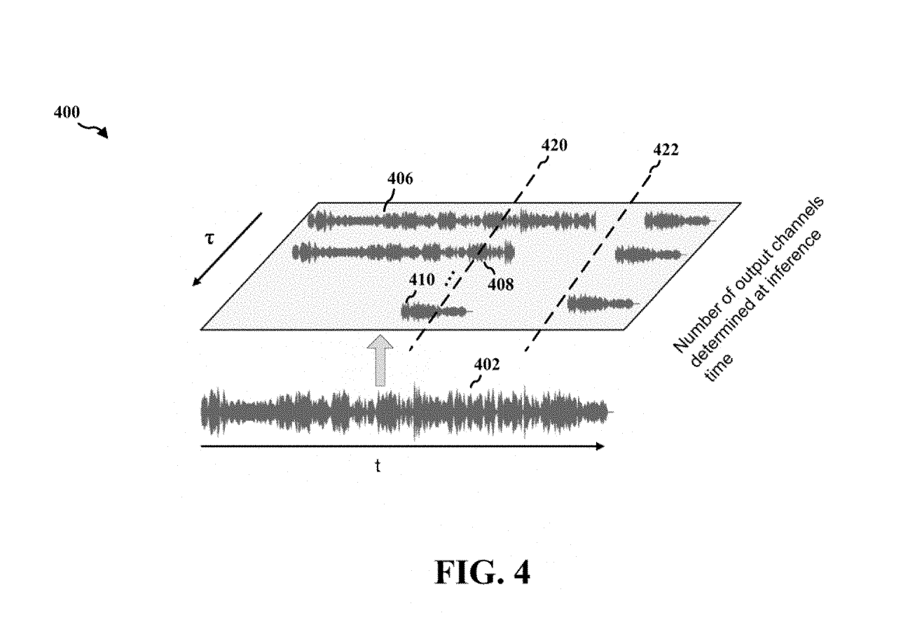

In certain aspects, the neural network 100, the deep convolutional network 200, or the recurrent neural network 300 may be configured to map a variable length sequence to a multi-dimensional variable length sequence. The configurations and operations of the neural network 100, the deep convolutional network 200, or the recurrent neural network 300 will be further described below with reference to FIGS. 4-10.

For a certain class of problems, at every time step, a fixed length input may need to be mapped to a variable length sequence. In this way, the output sequences may become a multi-dimensional sequence with two or more dimensions. Moreover, the mapping should be performed in a way that the predicted sequences at time t receive information from the surrounding sequences at earlier and later times, such as time t−1 or t+1. This class of problems may be referred to as multi-dimensional sequence prediction (MDSP) problems. Traditional neural networks, including traditional RNNs, may not be able to handle MDSP problems.

Blind source separation (BSS) is the separation of a set of source signals from a set of mixed signals, without the aid of information (or with very little information) about the source signals or the mixing process. Blind source separation is a particularly important problem that MDSP may be used to solve. A human may perform BSS of many signals with two independent receivers (ears). Traditional approaches to BSS cannot, thus requiring additional receivers and antennas, which may increase cost and bulk. Traditional BSS may need at least R receivers to separate S signals (i.e., R>=S). Additionally, S may also need be known in advance for traditional BSS. It may be desirable to have a method that can perform BSS when R<S and S is unknown.

One example where MDSP may be used is for a hearing aid. A person has, at most, two ears. However, the person may be in a crowded room with many voices. However, the person would like to hear a particular voice, or possibly to separate out all of the voices that are otherwise “mixed” together. This is the so-called “cocktail party” problem, which is of interest for speech recognition, hearing aids, and wireless systems (such as MIMO receivers). Due to size constraints, weight limitations, power constraints, cost and complexity reasons, it may be desirable to have less number of receivers R for MDSP. The number of signals, S, that are present at any time may not be known. Therefore, an algorithm, such as MDSP, may have commercial and practical benefit.

FIG. 4 is a diagram 400 illustrating an example of applying MDSP to blind source separation. In one configuration, the algorithm for applying MDSP to BSS may be performed by a neural network (e.g., the neural network 100, the deep convolutional network 200, or the recurrent neural network 300). In the example, one receiver may receive a mixed voice signal 402 that includes multiple voices mixed together. The number of individual voices mixed within the mixed voice signal 402 may be unknown. The mixed voice signal 402 may be continuous in the time dimension t for a unknown length of time. Therefore, the mixed voice signal 402 is a variable length sequence.

In one configuration, after applying MDSP to BSS, the mixed voice signal 402 may be separated into several channels (e.g., channels 406, 408, . . . 410) on the τ dimension. Each output channel may include an individual voice signal. The number of output channels may be determined at inference time. For example, at time 420, the output channels may include at least the channel 406, 408, and 410. However, at time 422, no channel may be identified and output. Therefore, the MDSP may determine S, the number of signals present. The output of the MDSP may be a two dimensional (dimensions t and τ) variable length sequence because of the sequence lengths in both dimensions t and τ vary.

In one configuration, the algorithm may automatically determine the number of signals without knowledge of the number of signals to be separated in advance. In one configuration, the algorithm may work when the number of receivers is less than number of signals (i.e., R<S).

Another example problem where MDSP may be applied is object detection in a video. A common problem for object detection is to identify the objects within a video, where the number of objects in any given frame is unknown. The input sequence may be a representation of a video, and the output sequence at each frame may be the location of the detected objects, however many are detected. Accordingly, one dimension in object detection of a video may be the time dimension t. The time dimension t may vary, for example, when the length of the video is unknown (e.g., in the case of live video). Another dimension of the object detection of the video may be the τ dimension, which may represent a set of objects (potentially an empty set) detected in the video. Because the objects and number thereof is unknown, the τ dimension may be variable length. Accordingly, a video may be a multi-dimensional variable length sequence.

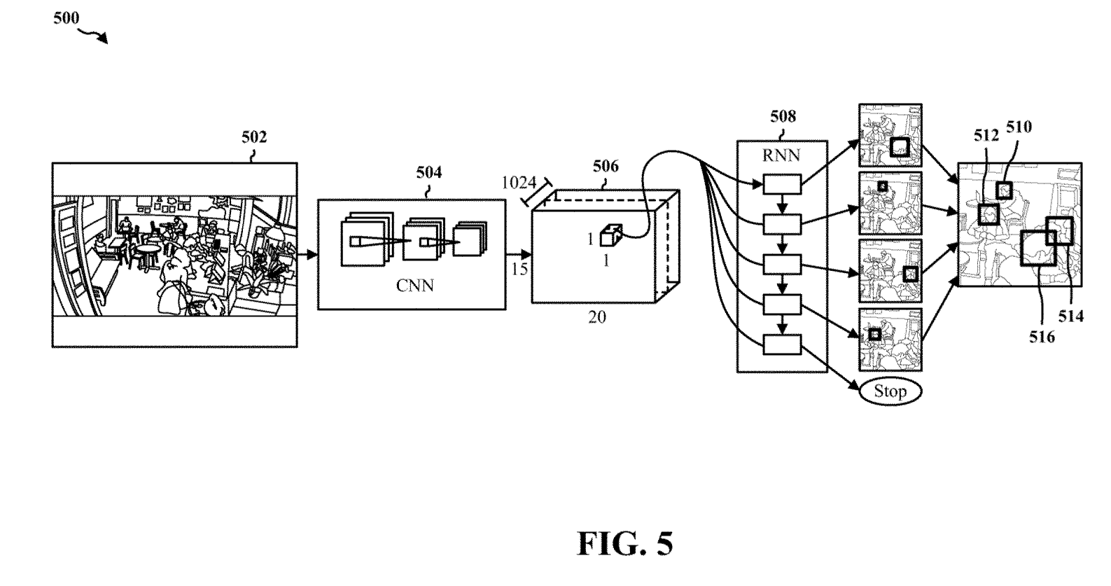

FIG. 5 is a diagram 500 illustrating an example of detecting objects in a single image 502. In the example, the single imaged 502 may be fed into a CNN 504, which may output a feature map 506. The feature map 506 may be provided to a RNN 508, which may identify one target object (e.g., a human face 510, 512, 514, or 516) at a time.

The number of objects in a scene may be unknown at inference time. Object detection in video may be treated as a 2-dimensional (2D) sequence learning problem, as the number of objects is a 1-dimensional (1D) sequence and the number of frames in the video is a 1D sequence. Therefore, the number of objects (e.g., faces) in a video may be a 2D sequence of arbitrary length in both dimensions. If there were 100 faces in a frame of a video, there may be a similar number of faces in adjacent frames. Therefore, leveraging the full extent of temporal/sequential information may lead to more accurate predictions.

In one configuration, after applying MDSP to object detection in a video, a 2D sequence of arbitrary length in both dimensions may be generated. One dimension of the 2D sequence is the number of frames in the video, and another dimension of the 2D sequence is the number of objects in each frame.

Multi-dimensional recurrent neural networks (MD-RNN) and multi-dimensional backpropagation through time (MD-BPTT) may perform a mapping from a fixed size multi-dimensional (MD) input to a fixed size MD output. One usage example is image segmentation, where the MD-RNN scans an image and assigns a category to every pixel (e.g. sky, water, sand, house, tree, person, etc.). However, the MD-RNN is constrained in that the relationship between the dimensions, or size, of the inputs and outputs must be known in advance. Having to know the relationships between the inputs and outputs in advance makes the MD-RNN less useful for problems such as blind source separation, because in practice the number of sources that are present at any given time may not be known. In contrast, MDSP may allow the sequence length of the input and the output to be of arbitrary (or unknown) length in all dimensions. For instance, the input may be one or more signals from a set of receivers. At every time step, the output may be zero or more sources that have been separated from the input sequence. The neural network may determine, “on the fly”, how many sources to separate based on the input signals. In this way, the neural network may generate a sequence in multiple dimensions. For example, the neural network may generate a 2D sequence in two dimensions, which may be referred to as t and τ, where t may be the normal time dimension, and τ may be the sequence length generated at any given time step. In the case of BSS, τ may be the number of sources heard by the neural network at a given time step. In certain aspects, more than two dimensions may be employed.

In one configuration, MDSP may be similar to the MD-RNN/MD-BPTT approach. However, MDSP may allow the input length in dimension t to be arbitrary, such that the RNN scans row by row (time step by time step) for an indeterminate amount of time steps. Additionally, MDSP may allow the output dimension τ to be arbitrary, such that at every time step, the RNN takes in one or more inputs in t and generates zero or more outputs in τ, without being constrained by the number of inputs in the dimension t. In this way, the output sequence is s(t, τ), where the range for τ may not be known in advance and may depend on t.

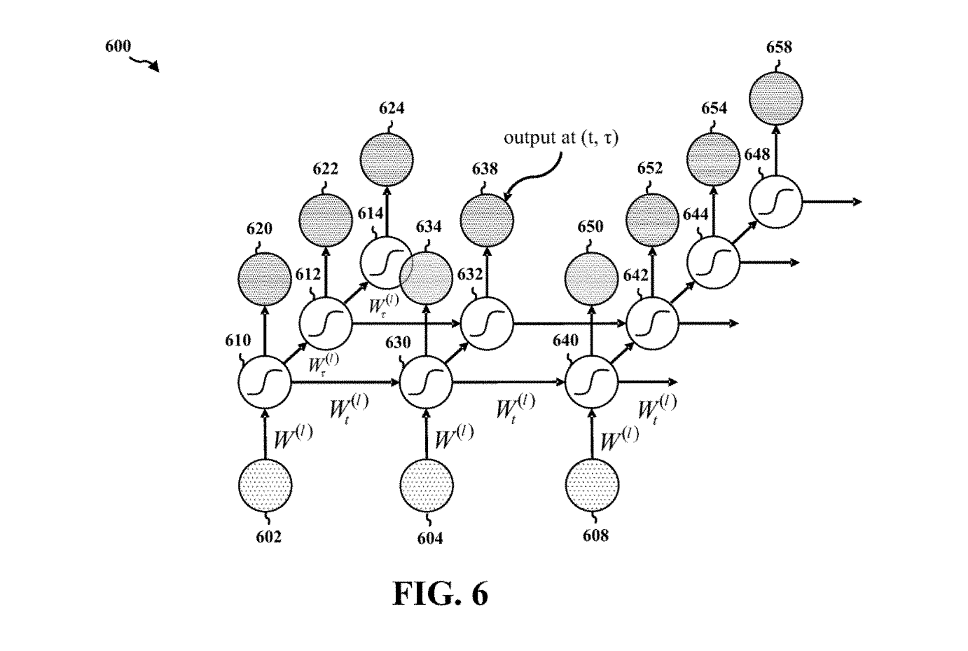

FIG. 6 is a diagram illustrating an example of a multi-dimensional sequence prediction network 600. In one configuration, the MDSP network 600 may be an RNN with forward and backpropagation that is unfolded (e.g., performed) in N dimensions. As illustrated, the MDSP network 600 may be unfolded in a 2D space that includes a time (t) dimension and a τ dimension. For each time step on the time dimension, there may be an input from at least one previous layer and a sequence of neurons on the τ dimension. Each of the sequence of neurons on the τ dimension may have a corresponding output.

For example, at a first time step on the time dimension, there may be an input from a previous layer (e.g., neuron 602) and a first sequence of neurons 610, 612, and 614 on the τ dimension. The first sequence of neurons 610, 612, and 614 may have corresponding outputs to neurons 620, 622, and 624, respectively. Similarly, at a second time step on the time dimension, there may be an input from a previous layer (e.g., neuron 604) and a second sequence of neurons 630 and 632 on the τ dimension. The second sequence of neurons 630 and 632 may have corresponding outputs at neurons 634 and 638, respectively. At a third time step on the time dimension, there may be an input from a previous layer (e.g., neuron 608) and a third sequence of neurons 640, 642, 644, and 648 on the τ dimension. The third sequence of neurons 640, 642, 644, and 648 may have corresponding outputs at neurons 650, 652, 654, and 658, respectively.

In one example aspect, the neurons 602, 604, 608 may be a layer at which input is received. For example, each neuron 602, 604, 608 may receive a respective time step of a sequence. Thus, neuron 602 may receive input of the sequence given by (t−1, τₗ₋₁), neuron 604 may receive input of the sequence (t, τ₁), and neuron 608 may be given by (t+1, τₗ₊₁). In one aspect, the output of one layer (l) may be given by a, shown in Equation 1. For example, the output of a neuron 604 may be given as a⁽¹⁾.

a^{(l)}(t,τ)=ƒ[a^{(l)}(t,τ)] Equation 1

In an aspect, the neurons 610, 612, 614, 630, 632, 640, 642, 644, 648 may be a hidden layer. The hidden layer may receive the outputs a^{(l)} of the previous layer. The output z^{(l)} of each of the neurons 610, 612, 614, 630, 632, 640, 642, 644, 648 may be given by Equation 2. For example, the output of a neuron 630 may be given as

z^{(l)}(t,τ)=W^{(l)}·a^{(l-1)}(t)+Wₜ^{(l)}·a^{(l)}(t−1,τ)+W_{τ}^{(l)}·a^{(l)}(t,τ−1) Equation 2

For example, for a neuron 630, the output of a previous layer a^{(l-1)} at time t may be multiplied by a weight W^{(l)} (e.g., a matrix or other convolutional operation). In an aspect, the weight W^{(l)} may be constant. The output z^{(l)} of each of the neurons 610, 612, 614, 630, 632, 640, 642, 644, 648 may be given as a vector or matrix. The each of the outputs z^{(l)} may be given to a respective neuron 620, 622, 634, 638, 650, 652, 654, 658, which may be an output layer. Accordingly, the neurons 620, 622, 634, 638, 650, 652, 654, 658 at the output layer may vary across each time step because the input sequence is variable length in the τ dimension.

In various aspects, the output z^{(l)} of each of the neurons 610, 612, 614, 630, 632, 640, 642, 644, 648 may be given to at least one of the other neurons 610, 612, 614, 630, 632, 640, 642, 644, 648 of the same layer. Accordingly, the output z^{(l)} of at least one of the neurons 610, 612, 614, 630, 632, 640, 642, 644, 648 may be linearly combined as an input to another of the neurons 610, 612, 614, 630, 632, 640, 642, 644, 648. For example, the output z^{(l)}(t, τ) from neuron 732 may be given as an input to neurons 712 and 742, as well as one or more other neurons.

In one configuration, unfolding along each dimension in the MDSP network 600 may not be fixed or pre-determined in length at every (t, τ). For example, there may be undetermined number of time steps on the time dimension, and/or undetermined number of neurons on the τ dimension at each time step.

In one configuration, temporal pooling may be implemented for the MDSP network 600. In one configuration, full sequential information from the prior time step may influence the sequence of neurons on the τ dimension for the next time step. For example, as illustrated in MDSP network 600, there is an interconnection between the neurons 612 and 632, as well as an interconnection between the neurons 610 and 630. Therefore, sequential information from the first sequence of neurons 610, 612, 614 may influence the second sequence of neurons 630 and 632. In one configuration, the weights for each interconnection between successive time steps of the MDSP network 600 may be the same (e.g., Wₜ^{(l)}).

In one configuration, full sequential information from the next time step may influence the sequence of neurons on the τ dimension for the previous time step. For example, as illustrated in MDSP network 600, there is an interconnection between the neurons 632 and 642, as well as an interconnection between the neurons 630 and 640. Therefore, sequential information from the third sequence of neurons 640, 642, 644, 648 may influence the second sequence of neurons 630 and 632. In one configuration, the weights for each interconnection between successive time steps of the MDSP network 600 may be the same (e.g., Wₜ^{(l)}).

In one configuration, sequential information from a prior neuron in a sequence of neurons on the τ dimension may influence the next neuron in the sequence of neurons on the τ dimension. For example, the neuron 610 may influence the neuron 612, which may influence the neuron 614. In one configuration, the weights for each interconnection between successive neurons in a sequence of neurons on the τ dimension may be the same (e.g., W_{τ}^{(l)}).

In one configuration, the output of a neuron in the MDSP network 600 may be a function of one or more of an input from a previous layer, an input from a previous time step, or an input from a prior neuron in the same sequence on the τ dimension. For example, the output of the neuron 630 may be a function of the output at neuron 604 multiplied by a weight (e.g., W^{(l)}) associated with the interconnection between the neuron 604 and the neuron 630, plus the output of the neuron 610 multiplied by Wₜ^{(l)}.

With MDSP, the weights connecting the RNN within successive time steps (e.g., Wₜ^{(l)}) may be the same or different from the weights connecting successive steps in the other dimensions (e.g., W_{τ}^{(l)}). Furthermore, it may be possible to input a sequence at every time step, which is mapped to a sequence at every output time step. Thus, a multi-dimensional sequence to a multi-dimensional sequence may be mapped. Moreover, the input to the network 600 may be the output from another neural network, such as a convolutional neural network, another RNN or some other machine learning algorithm. It is clear to those skilled in the art that this and other similar variations can be constructed from this disclosure. The RNN neuron used in the MDSP network 600 may be any artificial neural network neuron with feedback, such as the Long Short Term Memory (LSTM), Gated Recurrent Unit (GRU), Clockwork RNN, or any number of other variations.

There are many ways to train neural networks, including RNNs. The most common method at present is back propagation through time. A MDSP network may be trained using MD-BPTT, but it is generally understood that there are many ways to perform training of neural networks. In one configuration, the forward computation may be performed by “unfolding” the MDSP network. Similarly, MD-BPTT may proceed in the reverse order. A common variation on the above is the bi-directional RNN, where inputs are presented to one or more RNNs in parallel, where one RNN received the inputs in normal order, and the other parallel layer receives the inputs in reverse order. MDSP may be used in a reverse or bi-directional fashion.

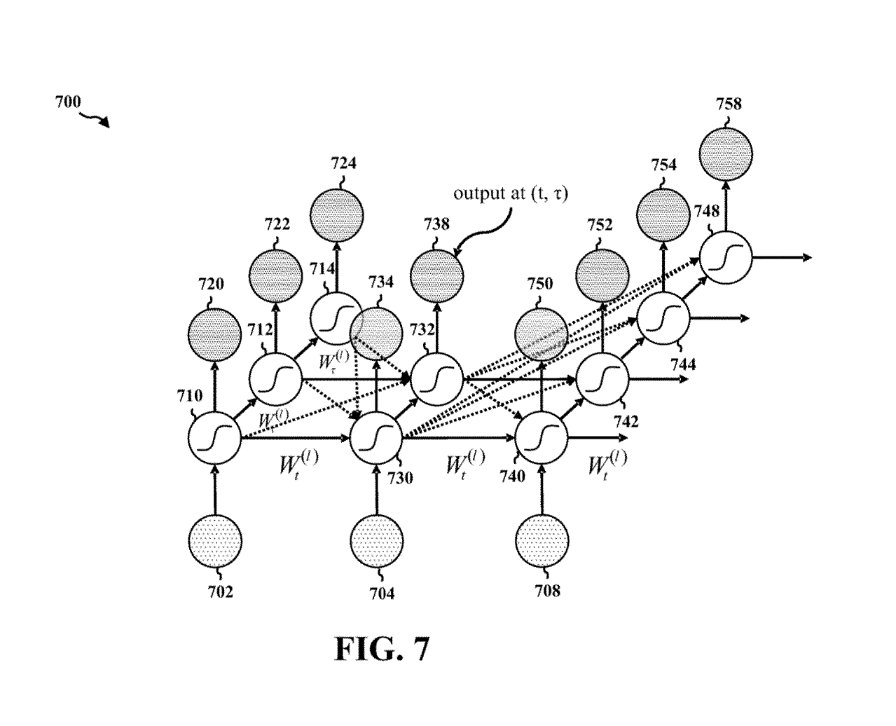

FIG. 7 is a diagram illustrating an example of a fully connected multi-dimensional sequence prediction network 700. As illustrated, the fully connected MDSP network 700 may be unfolded in a 2D space that includes a time (t) dimension and a τ dimension. For each time step on the time dimension, there may be an input from a previous layer and a sequence neurons on the τ dimension. Each neuron of the sequence of neurons on the τ dimension may have a corresponding output.

For example, at a first time step on the time dimension, there may be an input from a previous layer (e.g., neuron 702) and a first sequence of neurons 710, 712, and 714 on the τ dimension. The first sequence of neurons 710, 712, and 714 may have corresponding outputs at neurons 720, 722, and 724, respectively. Similarly, at a second time step on the time dimension, there may be an input from a previous layer (e.g., neuron 704) and a second sequence of neurons 730 and 732 on the τ dimension. The second sequence of neurons 730 and 732 may have corresponding outputs at neurons 734 and 738, respectively. At a third time step on the time dimension, there may be an input from a previous layer (e.g., neuron 708) and a third sequence of neurons 740, 742, 744, and 748 on the τ dimension. The third sequence of neurons 740, 742, 744, and 748 may have corresponding outputs at neurons 750, 752, 754, and 758, respectively.

In one configuration, unfolding along each dimension in the MDSP network 700 may not be fixed or pre-determined in length at every (t, τ). For example, there may be undetermined number of time steps on the time dimension, and/or undetermined number of neurons on the τ dimension at each time step.

In one configuration, full sequential information from the prior time step may influence sequence for the next time step. For example, the first sequence of neurons 710, 712, and 714 may be fully connected with the second sequence of neurons 730 and 732. Therefore, sequential information from the first sequence of neurons 710, 712, 714 may influence the second sequence of neurons 730 and 732.

In one configuration, full sequential information from the next time step may influence sequence for the previous time step. For example, the third sequence of neurons 740, 742, 744, 748 may be fully connected with the second sequence of neurons 730 and 732. Therefore, sequential information from the third sequence of neurons 740, 742, 744, 748 may influence the second sequence of neurons 730 and 732.

In one configuration, the MDSP networks 600 and 700 may be used to solve the BSS problem. In one configuration, the MDSP networks 600 and 700 may be used to increase performance in video object detection and video multi-activity detection.

Since the sequence length that is output from time step to time step is unknown, there may be some information lost from one time step to the next time step. For instance, if at time step 1 there is a sequence of 4 voices generated by the MDSP and at time step 2 there are only 2 voices separated, the basic MDSP method can lose information regarding the 3rd and 4th outputs (in τ) that were generated. To alleviate this problem, in one configuration, the output sequences from the prior (or following if in reverse) time step may be linearly combined to generate the input to the current time step, similar to a fully connected neural network layer connection. Since the precise length of the output sequence from step to step varies, the weights for these connections may be fixed to a constant (e.g., 1) during training, or the weights may be learned, for instance, under the assumption that there is a maximum sequence length per time step, TAU, and a maximum number of connections. And so, only a subset of the connections may be learned at any given time step. More elaborate schemes may also be possible.

An example for training the network to perform BSS may be as follows. Suppose a large number of different signals from one or more receivers, R, due to the “cocktail party” problem, may be provided either from data collection or physical simulation. The recordings of the individual signals (the “solution” to the problem, the “ground truth”) may also be available. Therefore, training may be performed in the usual way with MD-BPTT by presenting the input to the network at every time step, and computing the output. The error is then measured from the “ground truth” recordings and the weights of the network may be corrected to improve subsequent MDSP performance.

The precise order that the MDSP network separates the signals may not be known in advance. Those skilled in the art understand that there are a variety of methods for dealing with such a problem during training. One approach is to penalize the network with an order-independent cost function. Therefore, the cost of outputting three signals in order {1, 2, 3} or order {2, 1, 3} is the same. Another approach is “mean pooling”, where the output sequence at every time step is linearly summed, and then the error is computed from a sum of the ground truth signals. Another more sophisticated approach may train the network to output the signals in order of highest confidence to least confidence in the presence of the signal using Hungarian loss. Alternatively, the network may be trained to output the signals in order from “loudest” (or most signal power) to softest, or from most “male” (lowest pitch) to most “female” (highest pitch) sounding. Numerous variations on the methods may be possible.

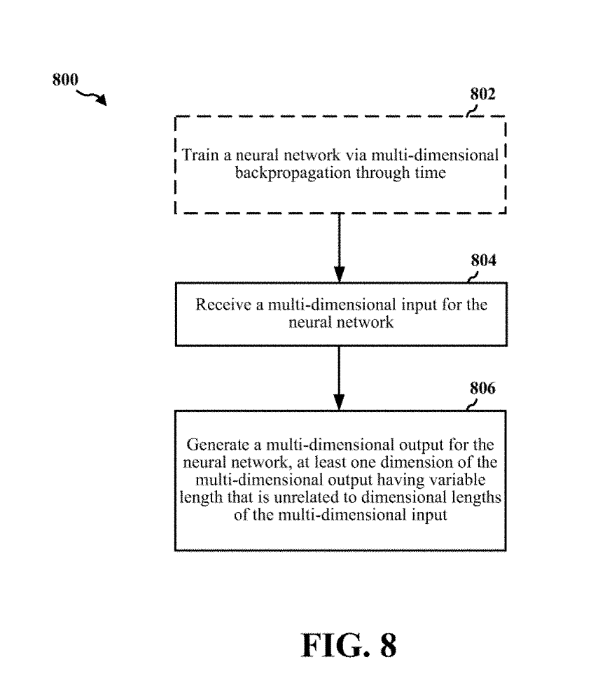

FIG. 8 is a flowchart 800 of a method of a neural network (e.g., the neural network 100, the deep convolutional network 200, the recurrent neural network 300, the MDSP network 600, or the MDSP network 700). In one configuration, the neural network may be a multi-dimensional recurrent neural network (MD-RNN). In one configuration, the method may be performed by a computing device (e.g., the apparatus 902/902′).

At 802, the device may optionally train a neural network via multi-dimensional backpropagation through time. In one aspect, the training of the neural network via multi-dimensional backpropagation through time may include providing a training sequence to the neural network. The training sequence may be comprised of at least two dimensions, e.g., time t and source τ. At least one of the dimensions may be variable length that is unknown to the neural network. For example, the neural network may not be provided the τ dimension and/or the t dimension, and the training sequence may be input to the neural network time step by time step. The training sequence may be propagated through the neural network in order to receive an output from the neural network. The output may be compared to an expected output to determine the error. Based on the comparison, one or more derivatives of error with respect to the weights may be calculated. In one aspect, the output sequence may be linearly summed at each time step to obtain a first sum, and the error is computed as a difference between the first sum and a second sum that is the linear sum of each time step of the expected output sequence. In one aspect, the error may be calculated using an order-independent cost function that considers weights and biases. The weights may be adjusted in order to reduce error. The training may be repeated, for example, until one or more gradients of error are within an acceptable threshold.

In the context of FIG. 6, the multi-dimensional sequence prediction network 600 may be trained via multi-dimensional backpropagation through time. In the context of FIG. 7, the multi-dimensional sequence prediction network 700 may be trained via multi-dimensional backpropagation through time

At 804, the device may receive a multi-dimensional input for the neural network. For example, the multi-dimensional input may be video. In another aspect, the multi-dimensional input may be an audio stream. The audio stream may include a number a sources, which may be unknown and which may vary from time step to time step.

For example, referring to FIGS. 4 and 6, the multi-dimensional sequence prediction network 600 may be provided a mixed-source signal 402. For example, each time step may be input to the neural network and input to a respective one of the neurons 602, 604, 608. For example, referring to FIGS. 4 and 7, the multi-dimensional sequence prediction network 700 may be provided a mixed-source signal 402. For example, each time step may be input to the neural network and input to a respective one of the neurons 702, 704, 708.

At 806, the device may generate a multi-dimensional output for the neural network. For example, the multi-dimensional output may be generated by feeding the multi-dimensional input through the neural network, which may generate the multi-dimensional output as a result. At least one dimension of the multi-dimensional output may have variable length that is unrelated to dimensional lengths of the multi-dimensional input. According to an example, the neural network may identify a time step of a multi-dimensional sequence. The neural network may identify a set of sources (potentially zero) in the time step. The neural network may separate each of the identified sources in each time step. In one aspect, information associated with the identified set of sources may be provided to at least one other neuron (e.g., a next neuron of a same layer) so that the identified time step may inform identification of the set of sources in the next time step. In one aspect, each neuron of a lowest layer (e.g., input layer) may calculate an output according to Equation 1. In one aspect, each neuron of a hidden layer may calculate an output according to Equation 2, which may be based on an output of a lower layer (e.g., input layer). In one aspect, each neuron of the hidden layer may provide an output to an output layer.

For example, referring to FIGS. 4 and 6, the multi-dimensional sequence prediction network 600 may generate a multi-dimensional variable length sequence, for example, including time 420 (t dimension) having channels 406, 408, and 410 (τ dimension) and time 422 having no channels. In an aspect, information related to time 420 having channels 406, 408, and 410 may be used by the network 600 to process the mixed-source signal 402 at time 422. For example, referring to FIGS. 4 and 7, the multi-dimensional sequence prediction network 700 may generate a multi-dimensional variable length sequence, for example, including time 420 (t dimension) having channels 406, 408, and 410 (τ dimension) and time 422 having no channels. In an aspect, information related to time 420 having channels 406, 408, and 410 may be used by the network 600 to process the mixed-source signal 402 at time 422.

In one configuration, a first dimension of the multi-dimensional input and the multi-dimensional output may be a time step dimension with arbitrary length. In one configuration, weights connecting the MD-RNN within successive time steps in the time step dimension may be the same as weights connecting successive steps in other dimensions of the MD-RNN. In one configuration, weights connecting the MD-RNN within successive time steps in the time step dimension may be different from weights connecting successive steps in other dimensions of the MD-RNN. In one configuration, an output sequence from a prior time step or a following time step may be linearly combined to generate an input to a current time step.

In one configuration, a first set of neurons for a first time step and a second set of neurons for a second time step may be fully connected, where the first time step and the second time step may be successive time steps. In one configuration, weights connecting a first set of neurons and a second set of neurons may be a constant. In one configuration, weights connecting a first set of neurons and a second set of neurons may be learned during training. In one configuration, an output sequence at each time step may be linearly summed to obtain a first sum and an error may be computed from a difference between the first sum and a second sum of an expected output sequence at the time step. In one configuration, the neural network may have an order-independent cost function.

In one configuration, the neural network may be used to solve an underdetermined BSS problem. In one configuration, the neural network may be used to improve performance in video object detection and video multi-activity detection.

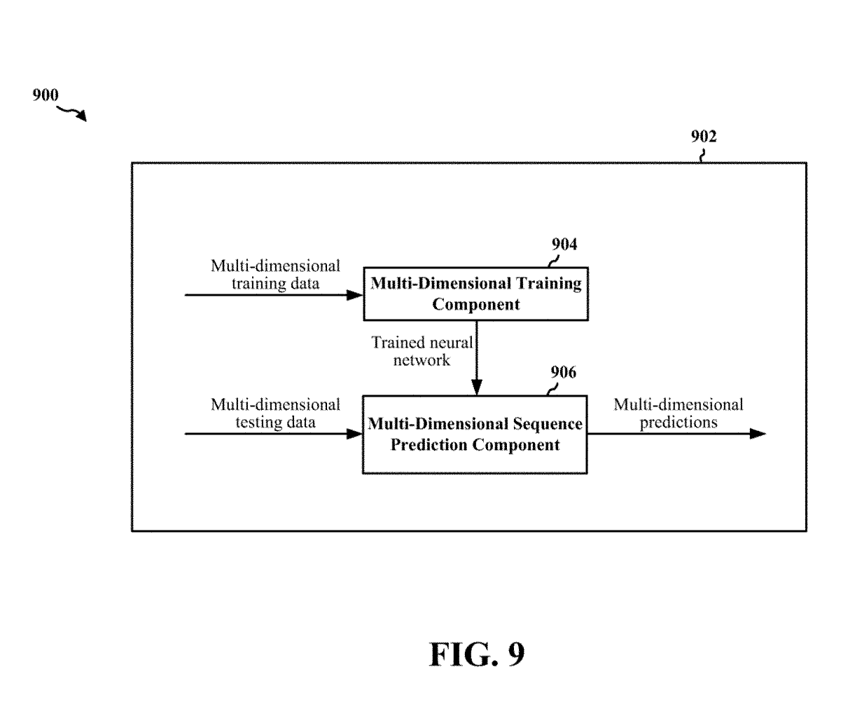

FIG. 9 is a conceptual data flow diagram 900 illustrating the data flow between different means/components in an exemplary apparatus 902. The apparatus 902 may be a computing device.

The apparatus 902 may include a multi-dimensional training component 904 that receives multi-dimensional training data and trains a neural network for MDSP. In one configuration, the multi-dimensional training component 904 may perform operations described above with reference to 802 in FIG. 8.

The apparatus 902 may include a multi-dimensional sequence prediction component 906 that receives multi-dimensional testing data, feeds the multi-dimensional testing data to a trained neural network generated by the multi-dimensional training component 904, and outputs multi-dimensional sequence predictions. In one configuration, the multi-dimensional sequence prediction component 906 may perform operations described above with reference to 804 or 806 in FIG. 8. For example, the multi-dimensional sequence prediction component 906 may be fed a multi-dimensional variable length sequence through the neural network, and may generate a multi-dimensional variable length sequence as a result. At least one dimension of the multi-dimensional output may have variable length that is unrelated to dimensional lengths of the multi-dimensional input. According to an example, the neural network may identify a time step of a multi-dimensional sequence. The neural network may identify a set of sources (potentially zero) in the time step. The neural network may separate each of the identified sources in each time step. In one aspect, information associated with the identified set of sources may be provided to at least one other neuron (e.g., a next neuron of a same layer) so that the identified time step may inform identification of the set of sources in the next time step. In one aspect, each neuron of a lowest layer (e.g., input layer) may calculate an output according to Equation 1. In one aspect, each neuron of a hidden layer may calculate an output according to Equation 2, which may be based on an output of a lower layer (e.g., input layer). In one aspect, each neuron of the hidden layer may provide an output to an output layer. A vector or matrix may be generated as the output.

The apparatus 902 may include additional components that perform each of the blocks of the algorithm in the aforementioned flowchart of FIG. 8. As such, each block in the aforementioned flowchart of FIG. 8 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

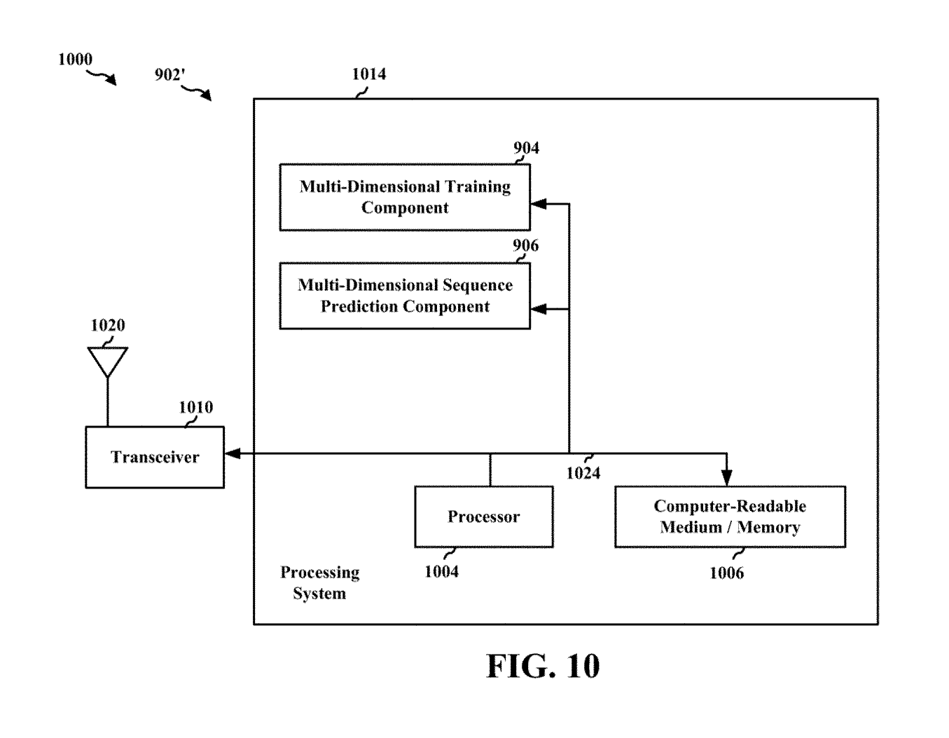

FIG. 10 is a diagram 1000 illustrating an example of a hardware implementation for an apparatus 902′ employing a processing system 1014. The processing system 1014 may be implemented with a bus architecture, represented generally by the bus 1024. The bus 1024 may include any number of interconnecting buses and bridges depending on the specific application of the processing system 1014 and the overall design constraints. The bus 1024 links together various circuits including one or more processors and/or hardware components, represented by the processor 1004, the components 904, 906, and the computer-readable medium/memory 1006. The bus 1024 may also link various other circuits such as timing sources, peripherals, voltage regulators, and power management circuits, which are well known in the art, and therefore, will not be described any further.

The processing system 1014 may be coupled to a transceiver 1010. The transceiver 1010 may be coupled to one or more antennas 1020. The transceiver 1010 provides a means for communicating with various other apparatus over a transmission medium. The transceiver 1010 receives a signal from the one or more antennas 1020, extracts information from the received signal, and provides the extracted information to the processing system 1014. In addition, the transceiver 1010 receives information from the processing system 1014, and based on the received information, generates a signal to be applied to the one or more antennas 1020. The processing system 1014 includes a processor 1004 coupled to a computer-readable medium/memory 1006. The processor 1004 is responsible for general processing, including the execution of software stored on the computer-readable medium/memory 1006. The software, when executed by the processor 1004, causes the processing system 1014 to perform the various functions described supra for any particular apparatus. The computer-readable medium/memory 1006 may also be used for storing data that is manipulated by the processor 1004 when executing software. The processing system 1014 further includes at least one of the components 904, 906. The components may be software components running in the processor 1004, resident/stored in the computer readable medium/memory 1006, one or more hardware components coupled to the processor 1004, or some combination thereof.

In one configuration, the apparatus 902/902′ may include means for receiving a multi-dimensional input for the neural network. In one configuration, the means for receiving a multi-dimensional input for the neural network may perform the operations described above with reference to 804 in FIG. 8. In one configuration, the means for receiving a multi-dimensional input for the neural network may include the multi-dimensional sequence prediction component 906 and/or the processor 1004.

In one configuration, the apparatus 902/902′ may include means for generating a multi-dimensional output for the neural network. In one configuration, the means for generating a multi-dimensional output for the neural network may perform the operations described above with reference to 806 in FIG. 8. In one configuration, the means for generating a multi-dimensional output for the neural network may include the multi-dimensional sequence prediction component 906 and/or the processor 1004.

The aforementioned means may be one or more of the aforementioned components of the apparatus 902 and/or the processing system 1014 of the apparatus 902′ configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of a neural network, comprising:
receiving a multi-dimensional input for the neural network; and
generating a multi-dimensional output for the neural network, wherein at least one dimension of the multi-dimensional output has variable length that is unrelated to dimensional lengths of the multi-dimensional input.

2. The method of claim 1, wherein the neural network is a multi-dimensional recurrent neural network (MD-RNN).

3. The method of claim 2, wherein a first dimension of the multi-dimensional input and a first dimension of the multi-dimensional output are each a time step dimension with arbitrary length.

4. The method of claim 3, wherein weights connecting the MD-RNN within successive time steps in the time step dimension are the same as weights connecting successive steps in other dimensions of the MD-RNN.

5. The method of claim 3, wherein an output sequence from a prior time step or a following time step is linearly combined as an input to a current time step.

6. The method of claim 3, wherein a first set of neurons for a first time step and a second set of neurons for a second time step are fully connected, the first time step and the second time step being successive time steps.

7. The method of claim 6, wherein weights connecting the first set of neurons and the second set of neurons are a constant.

8. The method of claim 2, wherein the MD-RNN is trained via multi-dimensional backpropagation through time (MD-BPTT).

9. The method of claim 8, wherein an output sequence at each time step is linearly summed to obtain a first sum and an error is computed from a difference between the first sum and a second sum of an expected output sequence at the time step.

10. The method of claim 8, wherein the neural network is trained with an order-independent cost function.

11. An apparatus for a neural network, comprising:
means for receiving a multi-dimensional input for the neural network; and
means for generating a multi-dimensional output for the neural network, wherein at least one dimension of the multi-dimensional output has variable length that is unrelated to dimensional lengths of the multi-dimensional input.

12. The apparatus of claim 11, wherein the neural network is a multi-dimensional recurrent neural network (MD-RNN).

13. The apparatus of claim 12, wherein a first dimension of the multi-dimensional input and a first dimension of the multi-dimensional output are each a time step dimension with arbitrary length.

14. The apparatus of claim 13, wherein weights connecting the MD-RNN within successive time steps in the time step dimension are the same as weights connecting successive steps in other dimensions of the MD-RNN.

15. The apparatus of claim 13, wherein an output sequence from a prior time step or a following time step is linearly combined as an input to a current time step.

16. The apparatus of claim 13, wherein a first set of neurons for a first time step and a second set of neurons for a second time step are fully connected, the first time step and the second time step being successive time steps.

17. The apparatus of claim 16, wherein weights connecting the first set of neurons and the second set of neurons are a constant.

18. The apparatus of claim 12, wherein the MD-RNN is trained via multi-dimensional backpropagation through time (MD-BPTT).

19. The apparatus of claim 18, wherein an output sequence at each time step is linearly summed to obtain a first sum and an error is computed from a difference between the first sum and a second sum of an expected output sequence at the time step.

20. The apparatus of claim 18, wherein the neural network is trained with an order-independent cost function.

21. An apparatus for a neural network, comprising:
a memory; and
at least one processor coupled to the memory and configured to:
receive a multi-dimensional input for the neural network; and
generate a multi-dimensional output for the neural network, wherein at least one dimension of the multi-dimensional output has variable length that is unrelated to dimensional lengths of the multi-dimensional input.

22. The apparatus of claim 21, wherein the neural network is a multi-dimensional recurrent neural network (MD-RNN).

23. The apparatus of claim 22, wherein a first dimension of the multi-dimensional input and a first dimension of the multi-dimensional output are each a time step dimension with arbitrary length.

24. The apparatus of claim 23, wherein weights connecting the MD-RNN within successive time steps in the time step dimension are the same as weights connecting successive steps in other dimensions of the MD-RNN.

25. The apparatus of claim 23, wherein an output sequence from a prior time step or a following time step is linearly combined as an input to a current time step.

26. The apparatus of claim 23, wherein a first set of neurons for a first time step and a second set of neurons for a second time step are fully connected, the first time step and the second time step being successive time steps.

27. The apparatus of claim 26, wherein weights connecting the first set of neurons and the second set of neurons are a constant.

28. The apparatus of claim 22, wherein the MD-RNN is trained via multi-dimensional backpropagation through time (MD-BPTT).

29. The apparatus of claim 28, wherein an output sequence at each time step is linearly summed to obtain a first sum and an error is computed from a difference between the first sum and a second sum of an expected output sequence at the time step.

30. A computer-readable medium storing computer executable code, comprising code to:
receive a multi-dimensional input for a neural network; and
generate a multi-dimensional output for the neural network, wherein at least one dimension of the multi-dimensional output has variable length that is unrelated to dimensional lengths of the multi-dimensional input.
